(19) United States
(12) Patent Application Publication
(10) Pub. No.: US 2026/0097313 A1
(43) Pub. Date: Apr. 9, 2026

(54) COOPERATIVE GAME ARTIFICIAL INTELLIGENCE (AI) VOICE CHAT

(71) Applicant: Sony Interactive Entertainment LLC, San Mateo, CA (US)

(72) Inventor: Sean Whitcomb, San Mateo, CA (US)

(21) Appl. No.: 18/908,704

(22) Filed: Oct. 7, 2024

(51) Int. Cl. A63F 13/67; A63F 13/54

(52) U.S. Cl. CPC A63F 13/67; A63F 13/54

(57) ABSTRACT

Methods and systems are provided for generating chat communication in a video game. One method includes accessing a gameplay database that includes dialog scripts from player interactions occurring during interactive scenarios of a cooperative video game. The method includes processing the dialog scripts to extract chat words between real players during the cooperative video game and labeling the chat words to correlate the chat words to one or more interactive scenarios and correlate the chat words to a game context, wherein over time an artificial intelligence (AI) model is trained using the chat words that are labeled to learn contextually relevant chat words for the cooperative video game. The method includes identifying a non-player character (NPC), during an instance of gameplay of the cooperative video game, the NPC is present in the cooperative video game while an avatar of a real player is present in a scene of the cooperative video game. The method includes generating one or more NPC chat words for the NPC using the AI model, the NPC chat words being audible to the real player.

### BACKGROUND

### 1. Field of the Disclosure

The present disclosure relates generally to computer implemented methods used for generating artificial intelligence (AI) assisted chat in cooperative gaming environments.

### 2. Description of the Related Art

The video game industry has seen many changes over the years. Users are now able to play video games using many types of peripherals and computing devices. Sometimes video games are played using a game console, where the game console is responsible for processing the game and generating the interactive input presented on display screens. Other times, video games are played in streaming mode, where a server or servers execute the game remotely and users provide input over a network connected device.

Although video game technology has seen many advances, some players find themselves in need of assistance. Depending on the particular game being played, users need to spend sufficient time learning game mechanics and understanding how to communicate with other users. This is especially true for cooperative games, which require users to communicate or chat with other users or with non-player characters during gameplay. A problem that often occurs during cooperative games is the need to chat with other users to accurately express a cooperative intent for executing a game mechanic or goal.

As players become more familiar with certain cooperative games, they also learn more about the interactive script, context and language by which players communicate in chat. Unfortunately, cooperative gaming requires players to be extra punctual in delivering the correct chat words and phrases that will timely deliver the gaming intent. Even for an excellent gamer, if the player cannot effectively chat with other users or non-player characters to communicate cooperative game intent, the gaming will suffer.

It is in this context that implementations of the disclosure arise.

### SUMMARY

Implementations of the present disclosure include methods, systems, and devices for enabling artificial intelligence (AI) assisted chat in cooperative gaming to improve chat communication. The embodiments address current state of the art deficiencies by training an AI model to comprehend the context of a cooperative game in real-time. In one embodiment, an AI model processes game data, including storyline progression, player actions, and cooperative dynamics, to enable generation of NPC dialogue that is both relevant and timely. AI-driven NPCs are capable of engaging in conversations, with real players (e.g., humans), that align with the unfolding game events, thereby creating a more immersive and interactive player experience. The system utilizes natural language processing (NLP) techniques and use of large language models (LLMs) to ensure that the words and phrases used by NPCs are appropriate to the specific context of the game.

As mentioned above, NPCs in cooperative gaming environments lack the ability to deliver life-like, contextually aware responses that are essential for maintaining player immersion and enhancing the gaming experience. Existing systems fail to account for the dynamic and evolving nature of cooperative gameplay, often resulting in NPCs making statements that are out of place, irrelevant, or mistimed. Such issues can lead to player dissatisfaction, as NPC comments may seem awkward, forced, or incorrect in relation to the storyline or current gameplay events.

In one embodiment, a method for generating chat communication in a video game is provided. The method includes accessing a gameplay database that includes dialog scripts from player interactions occurring during interactive scenarios of a cooperative video game. The method includes processing the dialog scripts to extract chat words between real players during the cooperative video game and labeling the chat words to correlate the chat words to one or more interactive scenarios and correlate the chat words to a game context. Over time an artificial intelligence (AI) model is trained using the chat words that are labeled to learn a chat style for the cooperative video game. The method includes identifying a non-player character (NPC) during an instance of gameplay of the cooperative video game. The NPC is surfaced in the cooperative video game while an avatar of a real player is present in a scene of the cooperative video game. The method includes detecting a location of the NPC in the scene to determine if the NPC is within a chat proximity to the real player, and generating one or more NPC chat words for the NPC consistent with the chat style of the cooperative video game using the AI model. The NPC chat words are audible to the real player and visually depicted as being output by the NPC toward the real player.

In some embodiments, the labeling of said chat words occurs after a normalizing function to filter out words from the dialog scripts. The normalizing function assists in identifying a relevance factor of the words in relation to the interactive scenarios and in relation to the game context, such that one or more of the words are not used as input to the AI model for training.

In some embodiments, the labeling includes tagging single words or groups of words from the chat words with context markers that assist in relating the chat words to said interactive scenarios and relating the chat words to the game context.

In some embodiments, the training of the AI model enables the AI model to predict chat words that are appropriate for a current interactive scenario based on real-time context analysis. And, the real-time context analysis identifies a time window during which said NPC is enabled to output said NPC chat words. If the time window is expired for said current interactive scenario, then said NPC will not output said NPC chat words even when the real player is within the chat proximity to the NPC.

In some embodiments, training said AI model further includes providing the AI model with custom chat words that relate to the cooperative video game or specific cooperative video games to fine tune the AI model.

In some embodiments, the identifying the NPC in the scene of the cooperative video game includes game state monitoring, and the game state monitoring includes analysis of game state during interactivity of the cooperative video game.

In some embodiments, the avatar of the real player is controlled by the real player in the scene and other scenes of the cooperative video game, and the avatar is made to interact in one or more of the interactive scenarios. The interaction in the one or more of the interactive scenarios by the avatar continually updates said game context.

In some embodiments, during said interaction by the avatar in the one or more interactive scenarios, data is processed by the AI model to identify said NPC chat words.

In some embodiments, real-time context analysis identifies a time window during which said NPC is enabled to output said NPC chat words, as relevant.

In some embodiments, if the time window is expired, then said NPC will not output said NPC chat words toward the avatar of the real player even when the real player is within the chat proximity to the NPC.

In some embodiments, the NPC chat words are throttled in output frequency based on an engagement level of the real player that controls the avatar. The engagement level is in part based on actions currently being taken by the player in the scene and state data analysis that identifies actions being taken by the player or required to be taken by the player in the interactive scenarios of the cooperative video game.

In some embodiments, the NPC chat words are throttled based on a user preference setting that identifies a level of engagement desired for the NPC or other NPCs in the scene during the interactive scenarios of the cooperative video game.

In some embodiments, the user preference setting includes an interactive sliding scale that sets the level of engagement desired for the NPC or other NPCs, wherein the level of engagement indicates whether the NPC or other NPCs should more aggressively or less aggressively chat with the avatar of the real player.

In some embodiments, the AI model is used to modify the NPC chat words for urgency triggered by the game context, wherein more urgency requires the NPC chat words to be delivered by the NPC to the real player in a language format that is briefer and more specific.

In one embodiment, a method for generating chat communication in a video game is provided. The method includes accessing a gameplay database that includes dialog scripts from player interactions occurring during interactive scenarios of a cooperative video game. The method includes processing the dialog scripts to extract chat words between real players during the cooperative video game and labeling the chat words to correlate the chat words to one or more interactive scenarios and correlate the chat words to a game context, wherein over time an artificial intelligence (AI) model is trained using the chat words that are labeled to learn contextually relevant chat words for the cooperative video game. The method includes identifying a non-player character (NPC), during an instance of gameplay of the cooperative video game, the NPC is present in the cooperative video game while an avatar of a real player is present in a scene of the cooperative video game. The method includes generating one or more NPC chat words for the NPC using the AI model, the NPC chat words being audible to the real player.

Other aspects and advantages of the disclosure will become apparent from the following detailed description, taken in conjunction with the accompanying drawings, illustrating by way of example the principles of the disclosure.

### BRIEF DESCRIPTION OF THE DRAWINGS

The disclosure may be better understood by reference to the following description taken in conjunction with the accompanying drawings in which:

FIG. 1 is a system diagram that broadly illustrates the use of an AI model predict and generate chat words utilized by a nonplayer character (NPC) that may interact with the real player, in accordance with one embodiment.

FIG. 2 illustrates another example of the use of dialog scripts, where such dialog scripts may be generated during one or more previous cooperative game place, in accordance with one embodiment.

FIG. 3A illustrates another example of training and AI model, from a plurality of cooperative game place, spread over multiple sessions of gameplay in accordance with one embodiment.

FIG. 3B illustrates another example of utilizing an AI model that has been trained for use in cooperative gameplay, and accordance with one embodiment.

FIG. 3C illustrates an example of a cooperative gameplay and the AI model, which is used to deliver NPC chat words to the NPC, which are directed toward the real player, in accordance with one embodiment.

FIG. 4A illustrates an example table of chat words and phrases that can be output by the NPC, in accordance with one embodiment.

FIG. 4B illustrates another embodiment where the AI model can be utilized in cooperative gameplay in order to assist real players to communicate properly with other players or with other NPC's during gameplay, in accordance with one embodiment.

FIG. 4C illustrates an embodiment where the AI model is utilized with the cooperative game.

FIG. 4D illustrates an example where a real player is able to communicate RPA chat words to another real player.

FIG. 4E illustrates a basic table 450 of example real player actual chat words and the conversion or generation of real player adjusted (RPA) chat words, in accordance with one embodiment.

FIG. 5 illustrates components of an example device and/or platform system that can be used to perform aspects of the various embodiments of the present disclosure.

### DETAILED DESCRIPTION

The following implementations of the present disclosure provide methods, systems, and devices for enabling artificial intelligence (AI) assisted chat in cooperative gaming to improve chat communication. The chat communication can be by the user to another player or can originate from a non-player character (NPC) that may be communicating with the player. Therefore, in modern cooperative gaming environments, there is a pressing need for more life-like and engaging responses from in-game characters, such as non-playable characters (NPCs). These characters often serve critical roles in driving the narrative forward, providing immersive experiences, and enhancing player engagement. However, current NPC interactions frequently fall short due to a lack of dynamic, context-aware dialogue that aligns with the evolving storyline and player actions.

In one embodiment, AI enabled methods are disclosed to allow NPCs to understand the nuanced context of words and phrases used during gameplay. This understanding is extended not only to the literal meaning of the language but also to the situational and emotional context in which these words and phrases are spoken. One embodiment enables NPCs to communicate effectively and meaningfully with players, thereby enriching the cooperative experience.

In still another embodiment, AI enabled methods avoid scenarios where NPCs make comments or statements that appear out of place, irrelevant, or poorly timed. Such instances can occur when the NPCs fail to recognize changes in the game's storyline, the player's objectives, or the dynamics of player interactions. When NPC dialogue does not accurately reflect the current context, it can break immersion, leading to awkward or inappropriate exchanges that detract from the overall gameplay experience. Ensuring that NPCs remain contextually relevant and responsive is essential for maintaining a coherent and engaging narrative flow in cooperative games.

In one embodiment, systems and methods are provided for enhancing the realism and contextual relevance of non-playable character (NPC) interactions within cooperative gaming environments. The invention involves training an artificial intelligence (AI) model to understand the contextual elements of a cooperative game, thereby enabling the model to produce data to generate and provide automated chat functionality for NPCs in real-time. This results in NPC statements that appear authentic, timely, and relevant to the ongoing game narrative and gameplay dynamics. The embodiments also include features that allow users to customize the responsiveness of NPC dialogue to suit player preferences and/or gameplay context.

In one embodiment, an AI model for chat is trained to understand the complex and dynamic nature of cooperative gameplay. The training process includes data collection, pre-processing, training of the AI model, fine tuning of the AI model, and optionally reinforced learning. For data collection, the system may collect extensive datasets from various cooperative games, including dialogue scripts, player interactions, game scenarios, and context-specific events. These datasets may include labeled data representing different gameplay contexts, such as combat, exploration, strategy discussions, and storyline progression. For preprocessing, the collected data undergoes preprocessing to normalize and clean the text. This includes tokenization, removal of irrelevant information, and annotation of key elements, such as entities, intents, and context markers. The preprocessing stage may also involve encoding the game-specific terminology and phrases to facilitate accurate understanding by the AI model. For training of the AI model, one embodiment may include using a neural network-based natural language processing (NLP) model, such as a transformer-based architecture, trained using supervised learning techniques.

In other embodiments, the AI model 120 can also utilize components of a Large Language Mode (LLM), or can interface with one or more external LLMs. In cooperative games, a Large Language Model (LLM) helps the AI model 120 understand player chat by interpreting natural language, including game-specific phrases and context. The AI uses generative capabilities to create dynamic, context-aware responses for NPCs, making them feel more interactive and responsive. For example, if players coordinate strategies or request help, the LLM helps the NPC understand and respond appropriately, offering advice or support based on in-game events. This enhances immersion by making NPCs act intelligently and react in a way that fits the game's mechanics and player actions.

The model is trained to predict appropriate NPC responses based on the input context. The training process may include multiple epochs of feeding the preprocessed data into the model, optimizing its parameters to minimize the error in generating contextually relevant dialogue. After the initial training phase, the model may be fine-tuned using specific datasets that focus on particular game genres or scenarios. This fine-tuning process may enhance the model's ability to handle diverse gaming situations, ensuring it can generate appropriate responses across various contexts. In some embodiments, reinforcement learning techniques are applied to further refine the model. NPC interactions are simulated, and the model's performance is evaluated based on player feedback or predefined reward functions. The model iteratively improves by adjusting its strategies to maximize positive outcomes, such as player engagement and narrative coherence.

In another embodiment, the system integrates the trained AI chat model into the game engine to enable real-time context analysis and response generation for NPCs. This process can include continuously or periodically monitoring the state of the game, including one or more of player actions, storyline progression, environmental conditions, and NPC status. The game state data is collected through various in-game sensors and event triggers. In one embodiment, the system can use the AI chat model to extract relevant contextual information from the monitored game state. This includes, by way of example, identifying one or more of key events, player objectives, dialogue cues, and emotional tone. The AI model processes these inputs to understand the current situation and the role of the NPC within that context. Based on the extracted context, the AI chat model generates appropriate dialogue for the NPC.

The model selects words and phrases that are relevant to the current game scenario, ensuring that the NPC's response is aligned with the ongoing events and storyline. The generated dialogue is crafted to appear natural and conversational, enhancing the realism of the NPC interactions. In one embodiment, the generated text-based dialogue may be converted into voice output using text-to-speech (TTS) technology. In one configuration, a TTS system is integrated with the AI model or is interfaced with the AI model, allowing it to produce voice responses that match the NPC's personality and tone. The voice output may then be synchronized with the NPC's animations and lip movements, creating a seamless interaction experience for the player.

In some embodiments, the system can provide mechanisms for customizing the NPC chat behavior based on user preferences and gameplay context. In one configuration, the game includes a user interface that allows players to adjust the verbosity and frequency of NPC dialogue. Players can access settings to specify how chatty they want the NPCs to be, ranging from minimal interaction to frequent conversational engagement. In one embodiment, players can issue voice commands to NPCs to adjust chat settings in real-time. For example, a player may say, “Focus on mission objectives,” “Only give me hints after I fail twice,” or “Talk less” or other words/phrases to communicate the preference.

Then, the voice commands may be processed by the AI model, which dynamically adjusts the NPC's dialogue behavior based on the input. Advantageously, the system can then update the NPC chat parameters without interrupting the flow of the game. In still another configuration, the system can provide predefined dialogue modes, such as “Assistance Mode,” where NPCs provide only gameplay-related help, “Narrative Mode,” where NPCs contribute to storytelling, and “Silent Mode,” where non-essential NPC chatter is minimized. These modes may be selectable by the user to tailor the gaming experience according to their preferences.

In still other embodiments, a feature can be set for optimizing the timing and relevance of NPC dialogue to ensure it aligns with the game's pace and events. The AI model can include a timing analysis component that evaluates the current game context to determine the optimal moments for NPC interaction. In one configuration, the system assesses one or more of player activity, game intensity, and narrative cues to decide when NPCs should speak. For example, if the player is engaged in a critical task, the system may delay NPC dialogue to avoid distractions.

In one embodiment, the system of AI model 120 may employ relevance filtering to ensure that NPC dialogue is pertinent to the current game scenario. For example, the system may be programmed to check or verify if the NPC's comments are appropriate for the ongoing events, storyline, and player objectives. Irrelevant or mistimed comments are filtered out to maintain the coherence and immersion of the game.

In still other embodiments, the system can employ adaptive response length functions. For example, the system may adjust the length and complexity of NPC responses based on the game context. In fast-paced or urgent scenarios, NPCs provide short, concise messages to convey essential information quickly. In contrast, during less intense moments, NPCs may engage in longer, more detailed conversations that enrich the narrative and provide background information.

In some embodiments, methods or systems enable game-state-dependent dialogue management to control NPC interactions based on the current state of the game. In one embodiment, the system may detect the player's activity and adapt NPC dialogue accordingly. If the player is actively solving a puzzle or engaging in combat, the system may suppress non-essential NPC dialogue to prevent interference. Conversely, if the player is exploring or in a dialogue-driven scene, NPCs may provide more commentary. In scenarios where quick decision-making is required, such as during cooperative missions, the system prioritizes short, actionable NPC messages.

The AI model may be used to select phrases that convey urgency and critical information, supporting rapid player coordination. The system may throttle less important dialogue to maintain focus on the immediate task. In still another embodiment, methods may use AI model to provide event-driven triggers to initiate NPC dialogue. Specific in-game events, such as the discovery of a new location, completion of an objective, or changes in the storyline, activate predefined dialogue responses. The AI model can be used to tailor these responses to fit the context, ensuring they are relevant and contribute to the narrative.

With the above overview in mind, the following provides several example figures to facilitate understanding of the example embodiments.

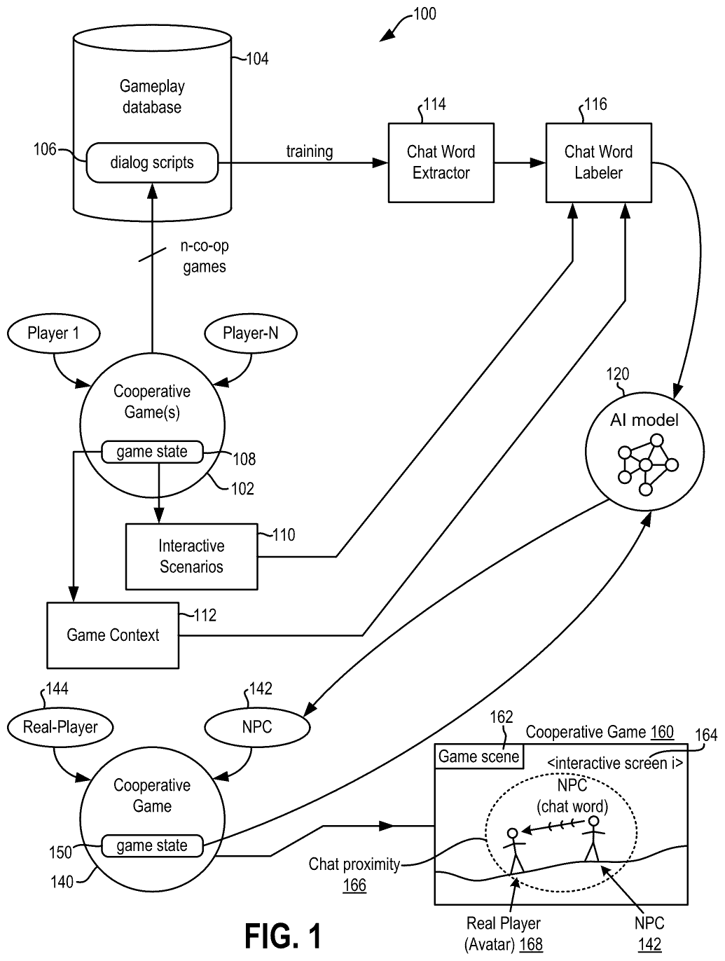

FIG. 1 is a system diagram 100 that broadly illustrates the use of an AI model 122 to predict and generate chat words utilized by a nonplayer character (NPC) that may interact with the real player, in accordance with one embodiment. In cooperative games 102, players can access games either locally on game consoles, online games, and streaming online games. These games enable multiple players to join the cooperative games 102, and each cooperative game will generate respectively game state 108. Game state 108 represents all information that is generated during gameplay for each of the cooperative games, and the game state can be utilized to enable playback of the game, restart of the game, or share portions of the game that were played with other players.

The game state 108 therefore includes all data necessary to re-create the status of the game, including all game assets, and including all information and data generated by the multiple players during the gameplay. Typically, game state 108 is saved on a server, such as a game server. In other embodiments, game state which can be stored locally on storage associated with the game console, a PC game, a mobile game device, or any other local or remote storage. In one embodiment, the game state 108 can be transferred to a gameplay database 104. By way of example, the game state which can be processed to identify dialogue scripts 106 of chat communication exchange between players during the cooperative gameplay.

By way of example, the dialogue scripts may be a subset of the game state 108, such that sentences, comments, chat statements, words, sounds, etc. can be stored as dialogue scripts 106, separately from the game state 108. In still other embodiments, the game state 108 can be stored in the gameplay database 104, and the dialogue scripts 106 can be generated in real time when requested for training, which will be discussed below. Broadly speaking, the dialogue scripts 106, if pre-identified from the various gameplay sessions of the cooperative games 102, can be stored and processed by the game database 104 for quick access.

Continuing with game state 108, the game state 108 can also be processed to identify interactive scenarios 110. The interactive scenarios 110 can be descriptive of different stages and interaction themes that occurred during the interactive play of the cooperative games 102. For example, interactive scenarios can identify specific game scenes, such as a boss fight, and ambush maneuver, tactical mission, cooperative gameplay mechanic scenarios, and the like. Generally speaking, the interactive scenarios 110 will depend on the type of cooperative game 102 being played, the scenes that are part of the cooperative game, the focus of the game, the objective of the game, the level of the game, the interactivity of the game, and many other factors.

The game state 108 can also analyzed to identify game context 112. In one embodiment, game context 112 refers to the current state of the game environment, encompassing all the conditions, rules, scenarios, and interactions that shape the player's experience at any given moment. As gameplay progresses, the game context 112 continually shifts based on various factors. These include the player's actions, such as movement, decision-making, and interactions within the game world, as well as dynamic changes in the environment like weather, level transitions, or new obstacles.

In one embodiment, the game story's progression also plays a role, as unfolding narratives and objectives influence the game context 112 as players complete missions, levels, quests, and/or tasks. Additionally, the rules and mechanics of the game may evolve, such as through the unlocking of new abilities or shifts in difficulty. In some embodiments, non-player characters and AI opponents contribute to the changing game context 112 as they react to the player's choices or external factors, presenting new challenges or opportunities. These ever-evolving elements make each moment in the game unique, contributing to the dynamic and immersive nature of gameplay.

During gameplay of a cooperative game 102, by players (e.g., Player 1, . . . Players N), the game state 108 is processed to identify dialog scripts 106. As mentioned earlier, dialog scripts 106 represent chat, text or other communication made between players of the cooperative game. These dialog scripts 106 can be words, chat words, groups of words, a single word, a sound, an expletive, a statement, a sentence, a game-specific command, a set of commands, etc. These dialog scripts 106, for the cooperative games 102, are used for training an artificial intelligence (AI) model 120. In one embodiment, training may occur using many past gameplays of different cooperative games 102, and can also occur using live and/or real-time gameplay of one or more cooperative games 102.

In some embodiments, the games need not be called “cooperative” games. Some games, although not cooperative, will still have multiple players, and in some cases NPCs. When a single real player is playing a game, an NPC may still communicate with the real-player, and this innovation provides the NPC chat words that an NPC can use to interact with one or more real players.

During training, a chat word extractor 114 is configured to identify chat words from the dialog scripts 106. Chat words, as described herein, can include a single word, two words, a group of words, textual statements, emoticons, and combinations of two or more thereof. Some words and statements that are part of a dialog scripts 106 are identified and are labeled as chat words. The identification includes logic that examines the dialog scripts 106 and the game state 102, in order to identify what statements or words should be considered chat words, during the extraction process.

Once the chat words are extracted and identified, a chat word labeler 116 is used to provide labels to the chat words. In one embodiment, the labeling refers to a process of assigning meaningful tags or identifiers (called labels) to data points, such as words, chat words, phrases, or other features. For extracted words, labeling means categorizing or identifying them based on their characteristics or their role in the specific task at hand. When applied to interactive scenarios of cooperative games, labeling involves categorizing extracted information from the game state 108 and the evolving game context 112. For instance, words or actions extracted from the game state 108 during cooperative play can be labeled according to their role in achieving a shared objective, fostering cooperation, or coordinating strategies between players.

In this context, labeling might involve identifying actions as cooperative moves, resource sharing, or strategic communication. These labels are assigned based on the current game context, such as the goals the players are working toward, the state of resources, or the status of each player's abilities. As the game progresses and the game state changes, new chat words or actions are extracted and labeled according to how they influence or reflect the evolving cooperation among players. For example, in a cooperative puzzle game, one player's move might be labeled as assisting if it helps another player complete their task, or as coordination if it involves synchronizing actions with teammates. Generally, labeling in this scenario assigns context-specific categories to extracted chat words using information from the game state. The information from the chat word labeler 116 can then be fed to the AI model 102, which helps the AI model 120 understand and predict patterns of cooperative behavior and what appropriate chat words may be, which can be used as NPC chat words of NPC in a cooperative game.

In one embodiment, an AI model 120 is trained to understand the types of chat words exchanged by players at different skill levels during cooperative games. The process involves several processing operations. As mentioned above, the AI model 102 is trained using large datasets of chat logs from cooperative games, e.g., the dialog scripts 106 stored in a gameplay database 104. These chat logs include the words or phrases exchanged between players during gameplay. Each word or phrase is labeled based on its context and purpose in the game. For example, some words might be labeled as strategic communication (e.g., “Let's attack now”), others as encouragement (e.g., “Great job!”), and others as coordination (e.g., “You take the left side”).

In one embodiment, the chat words are categorized or labeled to include the skill level of the players involved (e.g., beginner, intermediate, advanced). Over time, the AI model 120 learns patterns in the words exchanged by players at different skill levels and identifies which words are used in specific game contexts (e.g., resource management, combat, problem-solving). The AI model 120 is trained on many different cooperative games, allowing it to generalize across various gameplay scenarios. For each game, the AI model 120 can learn which chat words are commonly used by players who play well (i.e., higher skill levels). AI model 120 can learn when and why certain words or phrases are used (e.g., high-level players might use precise and efficient communication during complex tasks).

AI model 120 can associate certain chat words with successful outcomes, understanding that effective teams often use particular types of communication in key moments of the game. For example, the AI model 120 may learn that advanced players use concise instructions during time-sensitive tasks or provide strategic updates during team coordination efforts. In other embodiments, it is possible to generalize across many cooperative games, and the AI model 120 can be fine-tuned to learn the communication patterns specific to certain games. This means that the model will understand the unique strategies and chat words that skilled players use in a particular game (e.g., a cooperative puzzle game might require more discussion of patterns and clues, while a team-based shooter might involve rapid, directional commands).

In still other embodiments, the AI model 120 can be queried during live gameplay, allowing it to predict and generate relevant chat interactions in real time. This embodiment will occur in a game with a real player and NPCs (non-player characters). For example, the real player may be interacting with NPCs in a cooperative game. The AI model 120, having learned from both general and specific games, predicts which chat words the NPCs should use based on the current game state and context. For example, if the player is in a combat scenario, the NPC might suggest “Let's flank the enemy from the left” based on strategies learned from skilled players in similar situations. In one embodiment, the NPCs will dynamically interact with the real player using chat words that are contextually relevant, mimicking the behavior and communication patterns of real, skilled or non-skilled players.

The AI model 120 uses the player's current skill level, the game's cooperative context, and the real-time game state to determine the most appropriate words or phrases for the NPCs to use. This enhances immersion, as the NPCs can communicate effectively and intelligently, resembling the types of interactions the player might expect from human teammates in a well-coordinated game.

In some embodiments, as the AI model 120 interacts with more real players and new gameplay scenarios, it can continuously improve by learning from ongoing gameplay and chat data. This allows the AI model 120 to become better at predicting effective communication and adapting to the evolving skill levels of both NPCs and real players. For example, the AI model 120 becomes a dynamic partner in cooperative games, using learned communication patterns to help NPCs interact with real players in a way that feels authentic, responsive, and helpful.

Continuing with FIG. 1, an example of a cooperative game 140 shown, which is generating game state 150. In this example, the cooperative game 140 may be the game that is happening in real time, e.g. when the real player 144 is playing the game. As shown, during the cooperative game 140, the game logic may generate one or more NPC's, such as NPC 142. In one example, as a cooperative gameplay of the cooperative game 140 progresses, the game state 150 is shared with the AI model 120. They AI model 120 will use the game state 150 to extract and label chat words found in the dialog scripts being generated, as mentioned above during the training.

Therefore, during each successive cooperative gameplay, the actual game state 150 has been generated is utilized for the further training of the AI model 120. In one example, the cooperative game interface 160 is shown, which illustrates a game scene 162. The game scene 162 may be an encounter between a real player avatar 168 and an NPC 142. This encounter may represent one or more interactive scenarios 164 that occurred during the cooperative game 140, and illustrated in one or more screen presented user interfaces.

In this example, it is shown that a chat proximity 166 between the real player avatar 168 and the NPC 142 is within a chat proximity. The chat proximity may be a situation where the real player 168 avatar can see the NPC 142 on the same screen or game scene. In some embodiments, the NPC may be further away from the real player 168 avatar and therefore the NPC 142 will not be within chat proximity 162. For example, if the NPC 142 is facing a different direction or is not appearing to wish to engage in a dialogue with the real player avatar 168, then the chat proximity 162 will not be met.

However, in this case, the NPC 142 appears to be looking toward the real player avatar 168, and therefore the AI model 120 can generate NPC chat words that are communicated to the real player avatar 168. Generally speaking, the real player avatar 168 is a graphical illustration of the player controlled by the real player 144, and the real player 144 may be able to see on the screen but avatar 168. It will become apparent to the real player 144 that the NPC 142 is attempting to communicate or chat with the real player avatar 168. When this occurs, the real player 144 can listen to the NPC chat words coming from the NPC 142. In this embodiment, the NPC chat words provided by the NPC player 142 will be contextually relevant to the real player 144, since they are generated by the AI model 120, as described above.

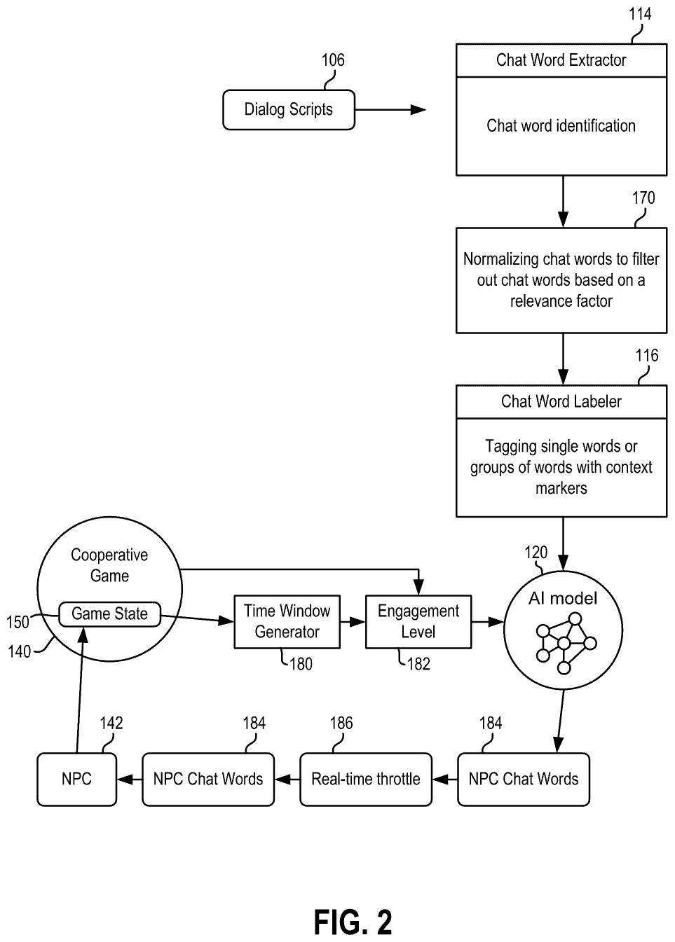

FIG. 2 illustrates another example of the use of dialog scripts 106, where such dialog scripts 106 may be generated during one or more previous cooperative game place. As mentioned above, the dialog scripts 106 may be obtained from a gameplay database 104. The gameplay's database 104 may also be located locally on a game console storage or in some other storage that is external to the game console or cloud-based storage.

As mentioned above, the dialog scripts 106 can be processed in order to find chat words. The chat word extractor 114 is utilized as mentioned above. In one embodiment, a normalizing function can be performed in operation 70, which can normalize chat words to filter out chat words based on a relevance factor. The relevance factor is a factor applied to the chat words to determine whether the chat which relate to the context of the game as well as the interactive scenario. For example, if the cooperative game is a puzzle solving game and the chat words identified relate to an adventure game, it is possible that the dialog scripts search is simply referring to some other game while they're playing the puzzle solving game.

Therefore, the normalizing function assists in filtering out chat words that are not relevant to the current interactivity being performed in the interactive cooperative game, and respective interactive scenarios. Once normalizing operations performed, the chat word labeler 116 applies the tagging to single words or groups of words with the context markers. As mentioned above, the context markers are metadata labels that provide relevance to the game context where the chat words were made as well as possible metadata labels that relate to the interactive scenario context. The labeled chat words are then processed by the AI model 120, as mentioned above.

In one operative example, a cooperative game 140 may be in the process of being played. During the gameplay of the cooperative game 140, a real player may be traversing different parts of the game, while game state 150 is being generated. While the game state is being generated, an additional operation of a time window generator 180 can continuously look at the state data 150 to determine when certain chat words are being generated, and if the game states dictates that a certain activity is still ongoing. The time window generator 180 will therefore generate a time window that is elastic and is dependent upon the scenario and context of what is occurring in the current game. For example, if there is a longer window for making a comment during a slow portion of the game, the time window generator will generate a longer time window.

If the context of the game requires speed, the time window generator will select a shorter time window. Longer time windows may be many seconds long or even minutes. However, some shorter time windows may be less than three seconds long or even fractions of a second if the scenario dictates a hurried need to make a comment. In one embodiment, real-time context analysis identifies a time window during which said NPC 142 is enabled to output said NPC chat words 184, wherein if the time window is expired for said current interactive scenario, then said NPC will not output said NPC chat words even when the real player is within the chat proximity to the NPC.

Once the time window generator 180 predicts the time window appropriate for the current gameplay, and engagement level 182 is also determined for the real player. The real player deeply engaged in some game mechanic and therefore the engagement level would be high. During high levels of engagement by the real player, or need for the real player to concentrate on a certain task, the NPC will not be triggered to produce NPC chat words that may interfere with the real players engagement of the game.

Accordingly, the engagement level 182 as well as the predicted time window from time window generator 180 is fed (or process by another piece of logic interfaced with the AI model 120) to the AI model 120. During the cooperative game 140, the real player may be provided with NPC chat words 184, which are presented as the NPC talking to the real player avatar, as mentioned above. In one embodiment, a real-time throttle 186 may also be applied to the NPC chat words 184. The NPC chat word 184 can be throttled in the form of speeding up the output of the NPC chat words 184, or even slow down the delivery of the NPC chat words 184 as delivered by the NPC 142.

In one embodiment, the NPC chat words 184 are throttled in output frequency based on an engagement level of the real player that controls the avatar. For example, the engagement level may be in part based on actions currently being taken by the player in the scene and state data analysis that identifies actions being taken by the player or required to be taken by the player in the interactive scenarios of the cooperative video game.

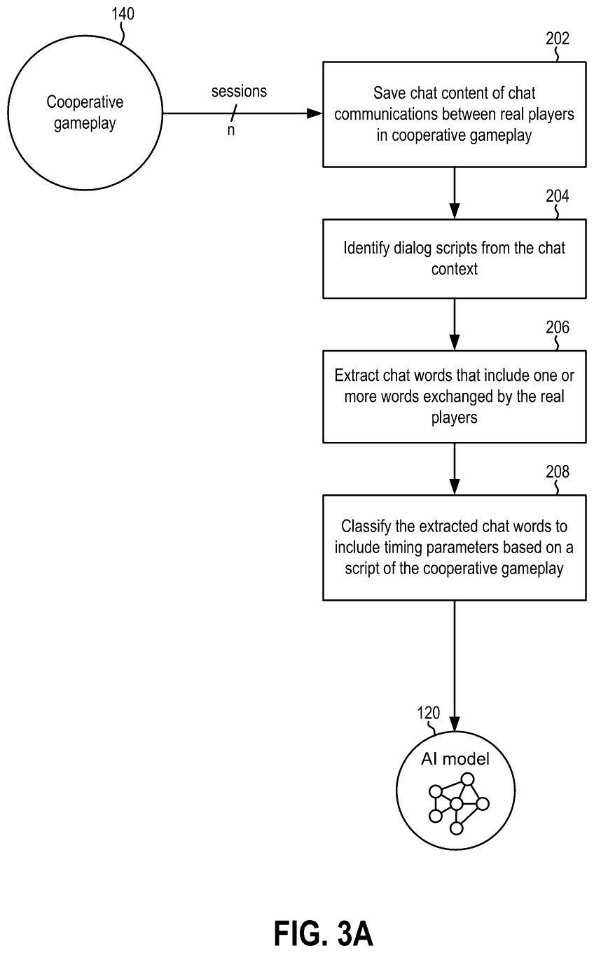

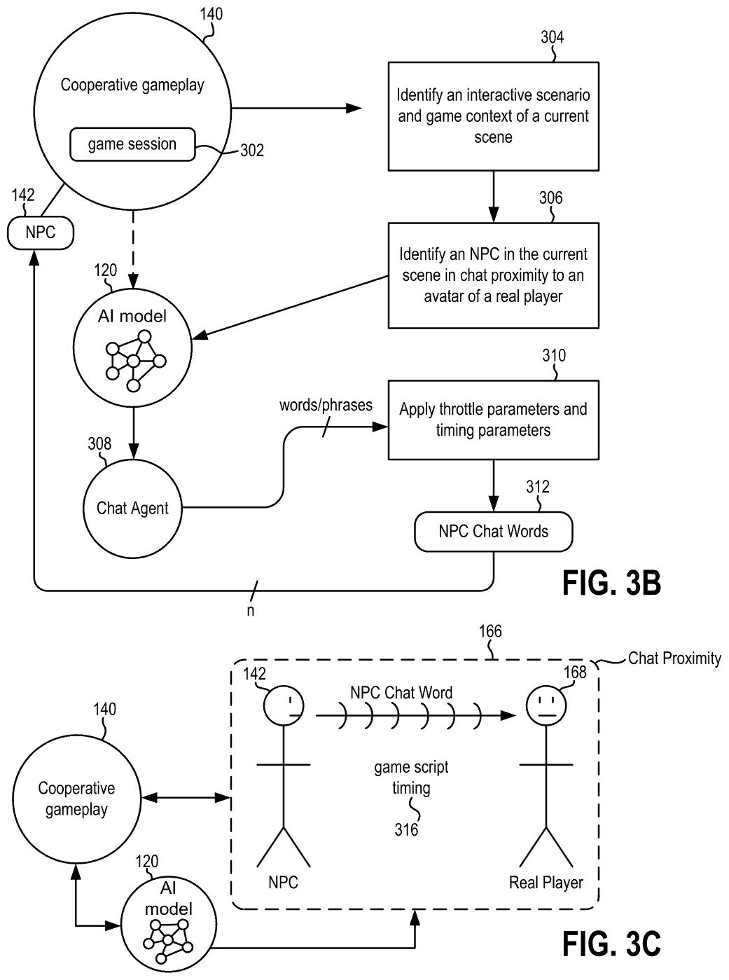

FIG. 3A illustrates another example of training and AI model 120, from a plurality of cooperative game place 140, spread over multiple sessions of gameplay. In this example, for each of the sessions of gameplay, operation 22 saves the chat content of chat communication between real players in a cooperative gameplay. This chat content represents the dialog scripts 106, which are identified from the general chat and communication content, which is extracted from the game state 108. In operation 204, dialog scripts are identified from the chat content.

The dialog scripts represent more relevant chat interchange between the players as opposed to the capture of all audio content that may be regarded as chat communication in operation 202. In operation 206, chat words are extracted from the dialog scripts. The chat words include one or more words that are exchanged by the real players during the one or more sessions of cooperative gameplay 140. In operation 208, extracted chat words are then classified to include time parameters based on a script of the cooperative gameplay. The timing parameters identify when and in what context that chat words were exchanged during the gameplay. For instance, were the chat words exchanged in a hurry during a hurried game scene scenario or were the chat words exchanged during a call face-to-face interchange. These time parameters produce metadata which is further classified as part of the chat words that are processed by the AI model 120.

FIG. 3B illustrates another example of utilizing an AI model 120 that has been trained for use in cooperative gameplay, and accordance with one embodiment. In this example, the cooperative gameplay 140 may be a game played by one or more players and one or more NPC's. During the gameplay, the game session 302 will have corresponding state data. For the state data produced during gameplay, operation 304 identifies an interactive scenario and game context of the current scene. In operation 306, and NPC is identified in the current scene, and chat proximity to avatar of a real player.

As mentioned above, there may be multiple NPCs in the game, but not all NPC's may be engaging with the real player or the avatar of the real player. For this reason, only NPCs which appear to be proximate to or attempting to engage with the real player will be provided with the logic from the AI model 120 for generating NPC chat words to the real player. In this manner, the identified NPC is signaled to AI model 120, which will then identify NPC chat words or phrases that the NPC can communicate to the real player or the avatar of the real player. In this example, a chat agent 308 can be utilized to process the output of the AI model 120. The chat agent may be used to receive data that is not yet formulated into communication words or chat words, and convert those chat words into text.

The text can then be generated and processed into words and phrases that can be audibly output by the game so that the NPC appears to be speaking those words and phrases. In some embodiments, the NPC's facial expressions can also be adjusted to correspond to the NPC chat words. In one embodiment, the words and phrases where output by the chat agent 308 can also be processed by throttle parameters and timing parameters in operation 310. As mentioned above, throttle parameters may dictate how fast the words and phrases are communicated to the real player or how slow.

The timing parameters similarly determine if a time window is appropriate for delivering the NPC chat words. As mentioned above, if the scene is changing quickly then the chat words may become stale or not relevant to what is currently occurring in the game. For this reason, not all NPC chat words are output, but are first processed to determine if the timing windows are appropriate and also the delivery using the throttle parameters. At this point, the NPC chat words 310 that should be delivered to the NPC 142 or output. The NPC chat words 310 will have passed a filter to determine that they are still timely and the delivery using the throttle parameters will be consistent with the present interactivity in the interactive scene.

FIG. 3C illustrates an example of a cooperative gameplay 140 and the AI model 120, which is used to deliver NPC chat words to the NPC 142, which are directed toward the real player 168. A chat proximity 166 may be identified when a common distance between players for communicating chat words is present in the current scene. In some embodiments, certain games enable chat words be exchanged even when players are not directly looking at each other or relatively closely. For example, in some games where players are searching for a treasure, the players may be spread out, but the players may still be able to chat with each other.

In that case, the chat proximity 166 will still be valid, and the chat can still be delivered between the NPC chat word from the NPC to the real player 168. Accordingly, the chat proximity 166 will be dependent on the game context 112 that is currently in process, so that the type of communication provided by the NPC to the real player appears to be typical and appropriate as if the NPC were a real player. In this illustration there is a single real player 168 and a single NPC 142. However, it should be understood that communication may be occurring between multiple real players and multiple NPC's during certain types of scenarios of cooperative gameplay 140.

In some embodiments, the NPC chat words 310 will also be delivered in a specific style, or chat style. A chat style refers to the speed of the audio output (i.e., of the NPC chat words), the tone of the audio output, the dialect of the audio output, the gender of the audio output, the audio level or magnitude of the audio output, and a type of correspondence of the chat style to the look and feel of the NPC. For example, if the NPC is an athlete participating in a competitive male event, the chat style may be adjusted to correspond to the look and feel of the NPC when presented in the interactive scene.

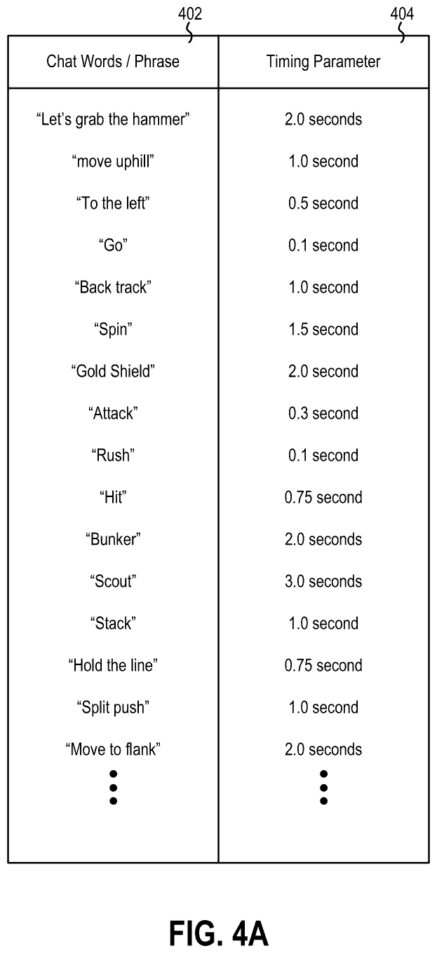

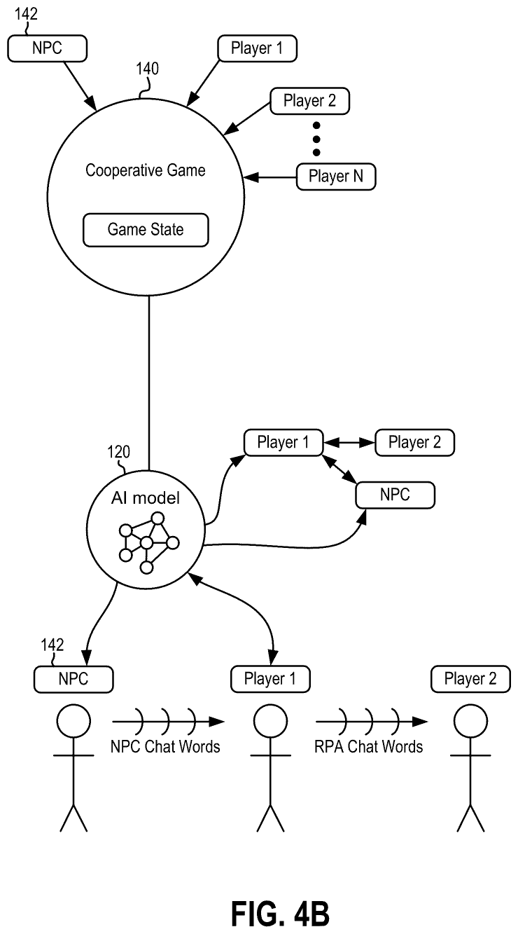

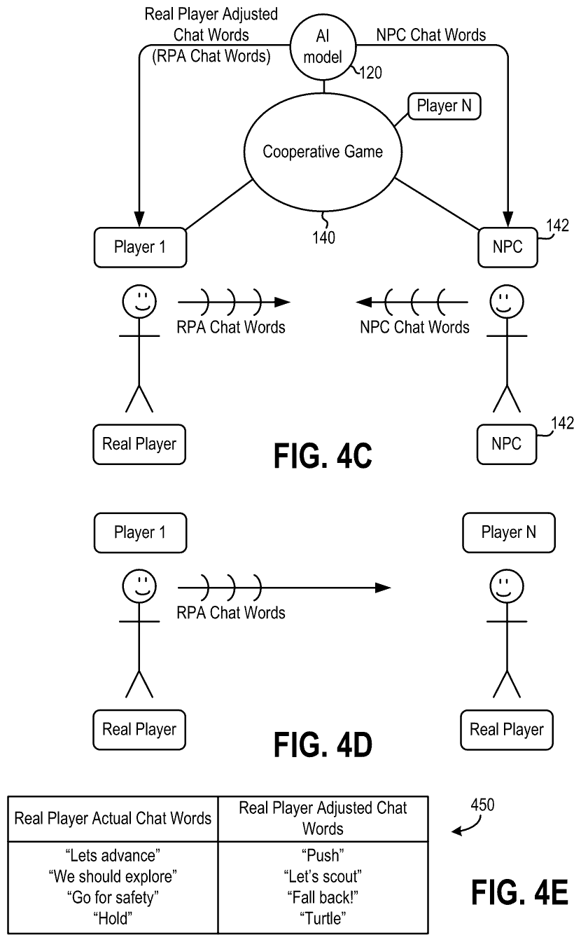

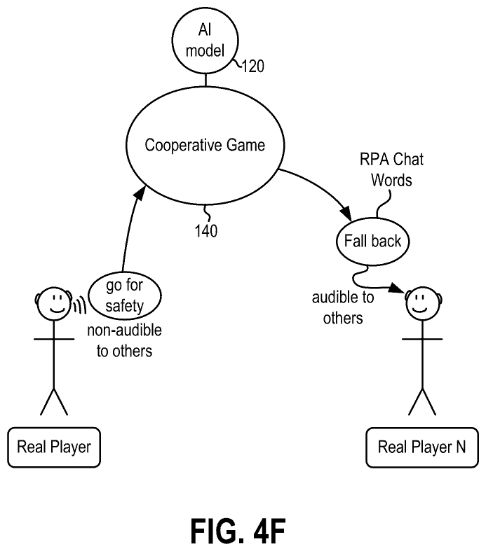

FIG. 4 illustrates an example table of chat words 404 and phrases that can be output by the NPC, in accordance with one embodiment. As mentioned above, the types of chat words can vary depending on the type of game, and the type of contacts involved in the cooperative game. Furthermore, the processing not only identifies the NPC chat words that would be output by an NPC, but also timing parameters 404. The timing parameters 404 are dynamically applied to the different chat words 402, that are identified by the AI model 120. Furthermore, the timing parameters 404 will vary depending on the context of the game at that specific moment when the NPC would be outputting the NPC chat words.

In one example, if the NPC chat words were to say “Let's grab the hammer” and the scenario is not so rushed, the timing parameters can set an approximate prediction that the output of those chat words should be within 2.0 seconds. That is to say, the specific and best time to say those words can vary, but can be output during the next two seconds at the best particular time. In contrast, if the chat word were to be “Rush” and the context requires that the NPC chat word be delivered quickly, then the tiny parameter would set a very quick exemplary time of 0.1 second.

Consequently, the output of NPC chat words are not only customized to appear relevant for the scenario, but also must be output in accordance with the timing parameters 404, which set timing windows for the delivery of the specific NPC chat words that are identified by the AI model 120. Again, the chat words and phrases that are identified by the AI model 120 will vary depending on the specific cooperative game, and the scenarios and context in which those NPC chat words should be delivered, i.e., output by the NPC and directed toward a real player or an avatar of a real player.

These embodiments collectively enhance the quality of NPC interactions in cooperative gaming environments by leveraging advanced AI techniques. The AI chat model 120 is trained to understand the complex dynamics of gameplay, enabling it to generate contextually aware and realistic dialogue for NPCs.

Customization options allow players to adjust NPC behavior to suit their preferences, while timing and relevance optimization ensure that NPC interactions enhance rather than disrupt the gaming experience. By way of example, real players can have a controller user interface that dictates the amount of interactivity the desire from NPC's. In some cases, players desire less communication with NPC's or other players, and that communication can be done by user interface, slider, voice command, or some other indicator. In other embodiments, a real player can have preferences set so that the NPC can provide different or specific types of NPC chat words. For example, the customization can't dictate that the NPC should only communicate tactical information to the real player, or never provide hints to the real player, or always provide chat words in a helpful manner, or only provide chat words when the scenario becomes difficult for the player, or other preferences that may be set by the real player or real players. This assist in having the AI model 120 be sensitive to the player's desires, and the player's settings can also change from game session to game session.

FIG. 4B illustrates another embodiment where the AI model 120 can be utilized in cooperative gameplay in order to assist real players to communicate properly with other players or with other NPC's during gameplay, in accordance with one embodiment. This embodiment may be enabled responsive to selection of a chat assist mode by the player. In another embodiment, if the player has not demonstrated a certain level of skill for the cooperative game, e.g., using historical gameplay metrics, the chat assist mode selection may be made automatically for the player. In some embodiments, the chat assist mode selection can be toggled on or off during gameplay using voice commands, gestures, GUI selections, and/or combinations thereof.

For example, for certain gameplay scenarios the real player may desire assistance, so the player selects to activate the chat assist mode or setting. In other embodiments, the real player can toggle it off or on at any time. As shown, cooperative game 140 will generate game state during the gameplay of one or more players, which can include real players and the gameplay of NPC's 142. During gameplay, the AI model 120 will utilize the training described above, and will also continue to learn during each iteration of gameplay.

It is optional to require the AI model 122 continue to learn, but it is one option to continuously learn during all sessions of gameplay or at least select the game session's gameplay as may be required or desired.

In this example, Player 1 is interacting in the cooperative gameplay enabled by cooperative game 140. An NPC 142 is also shown in at least one scene of the cooperative gameplay. As described above, NPC 142 can be configured to output NPC chat words, when chat is directed toward a real player, e.g. Player 1. In another embodiment, the AI model 120 can also enable chat assist mode for verbal output of Player 1, e.g., when Player 1 communicates with other players such as Player 2 or even when communicating with an NPC. By way of example, the verbal output of Player 1 can include chat words, which are captured from the audio output of Player 1.

However, instead of audibly conveying the verbal output of Player 1 so that others play the game can hear Player 1's chat words, the verbal output is processed using chat assist mode with the assistance of AI model 120. For example, the verbal output can be processed to identify dialogue scripts. The dialogue scripts may include sentences or phrases or expressions or sounds being output by Player 1. This verbal output is then processed through chat word extraction and chat word labeling, which is communicated and/or processed in real-time the by AI model 120. Utilizing the AI model 120, the chat words being generated by the verbal output of Player 1 can be adjusted so that the chat words are more relevant to the gameplay.

For instance, the real player may not be familiar with the typical jargon utilized in the game, and communicating with other players in basic language may be confusing or may place the player at a disadvantage. In some embodiments, the language required to play the game, where chat words are exchanged in cooperative games, require specific formats or code words. Experienced players will learn those codewords and formats, and therefore would be able to quickly output the correct chat words that would allow advancement or better experiences in the cooperative gameplay.

Players that are more novice or beginners, may simply utilize basic language or words that may make no sense to other players. This could be a serious disadvantage to all players, since many cooperative games require cooperation to achieve goals, advanced levels, and the like.

In one embodiment, once the verbal output of Player 1 is analyzed using the AI model 120, the verbal output is converted into Real Player Adjusted (RPA) chat words. The RPA chat words are words that are converted or identified to be more specific or intelligible to the type of game being played, and the context in which the communication is occurring. By way of example, if the verbal output by Player 1 had been “Let's advance,” the AI model 120 will assist in converting those chat words into “Push.”

In the context of a cooperative game being played, the chat words “push” is understood that Player 1 is requesting that another player participate in an advance toward some goal. In some embodiments, the RPA chat words may be similar to the original verbal output of player, but the RPA chat words are more context relevant and can be adjusted for a typing window as well as throttling. In one embodiment, the generation of the RPA chat words can be insubstantial real-time. The capture of the verbal output by the player can be processed in seconds, and sometimes in fractions of a second that would appear to others asked to be instantaneous to an observer watching Player 1 communicate and chat words.

To appear to be in substantial real-time, the capturing of the original audio of the player and outputting of the RPA, the processing is designed to be output within 2 seconds. If the AI model 120 and cooperative video game is an online game or streaming, the processing can be performed locally at a game console or can be performed on a server or servers. In some cases, the transmission time, e.g., network communication time between a server and client device can impact the speed of generating and outputting the RPA chat words. However, since audio is light weight as compared to video, the RPA chat words can be generated and output in less than 1 second, e.g., in 0.5 seconds or less. At that speed, the perception to a human viewing RPA chat words will appear to be output nearly identical to real-time.

Player 1 can therefore be communicating with other players, such as Player 2, utilizing the RPA chat words. Player 1 can also be communicating with an NPC utilizing the RPA chat words. In some embodiments, the NPC 142 can communicate using NPC chat words to Player 1, while Player 1 also communicates with NPC using RPA chat words. Accordingly, the AI model 120 can be implemented to facilitate communication not just by NPC's to real players, but real players to NPC's and real players to other real players.

FIG. 4C illustrates an embodiment where the AI model 120 is utilized with the cooperative game 140. The cooperative game 140 is shown to include gameplay by Player 1, NPC 142, and other real players Player N. This example shows that the AI model 120 can be utilized to generate chat words for real players, such as the real player adjusted chat words provided to Player 1, while also providing NPC chat words to NPC 142. As shown, a real player's audible chat words are then converted into RPA chat words that can be communicated to NPC 142. At the same time, NPC 142 can also be communicating NPC chat words to the real player.

FIG. 4D illustrates an example where a real player is able to communicate RPA chat words to another real player. In this embodiment, other real players listening to the RPA chat words will feel more comfortable playing with the real player because the real player understands the nomenclature, typical words used, the use of coded words, the timing of delivery of certain words, the context specific word selection, and/or when chat words should not be spoken. For instance, a real player can generate an audible statement, but because the AI model 120 has processed that statement before delivering it to other players, those chat words can simply be dropped or eliminated.

For example, those chat words may not be timely, may be inappropriate, may be out of context, may be offensive, or simply not relevant. This type of filtering of chat words by real players enables real players to more immersive level play games, and achieve goals in a cooperative game environment where other players expect that type of chat word communication.

FIG. 4E illustrates a basic table 450 of example real player actual chat words and the conversion or generation of real player adjusted (RPA) chat words, in accordance with one embodiment. As shown, the chat words a real player (e.g. actual words identified from sentences or statements uttered in audio detected from the real player) communicates can be transformed and/or adjusted to be contextually relevant, time-window appropriate, and/or throttle adjusted.

By way of example, actual chat words could be: “Let's advance”, transformed to “Push”; “We should explore”, transformed to “Let's scout”; “Go for safety”, transformed to “Fall back!”; “Hold”, transformed to “Turtle.” It should be understood that these are only some examples, and the exact words and phrases that the transformation produces using the AI model 120 will depend on the context of the game, the interactive game scene, level of skill of the players, the urgency of the gameplay, the relevance gameplay, etc.

FIG. 4F illustrates an example where audible output by a real player is made non-audible to enable transformation into RPA chat words that become audible to other players, in accordance with one embodiment. In this example, a real player might utter the words “Go for safety,” which are not audible to other players playing the cooperative game. However, using the AI model 120 and other logic associated with cooperative game 140, those uttered words can be transformed into RPA chat words.

The RPA chat words generated, and this example are chat words “Fall back.” The RPA chat words would, in this example become audible to other players or NPC's. For all other players or NPCs, the words coming out of the mouth of the real player or the avatar of the real player, will appear to be chat words “Fall back.” In the context of the current game and the scenarios occurring in the interactivity, these chat words are more context appropriate and would be more understood to other players. Accordingly, the skill level and cooperative help provided by the real player can be elevated, as seen by other players, which will make the gaming experience for all more realistic and interesting.

By implementing these features, the invention provides a comprehensive solution for creating more immersive and engaging cooperative games.

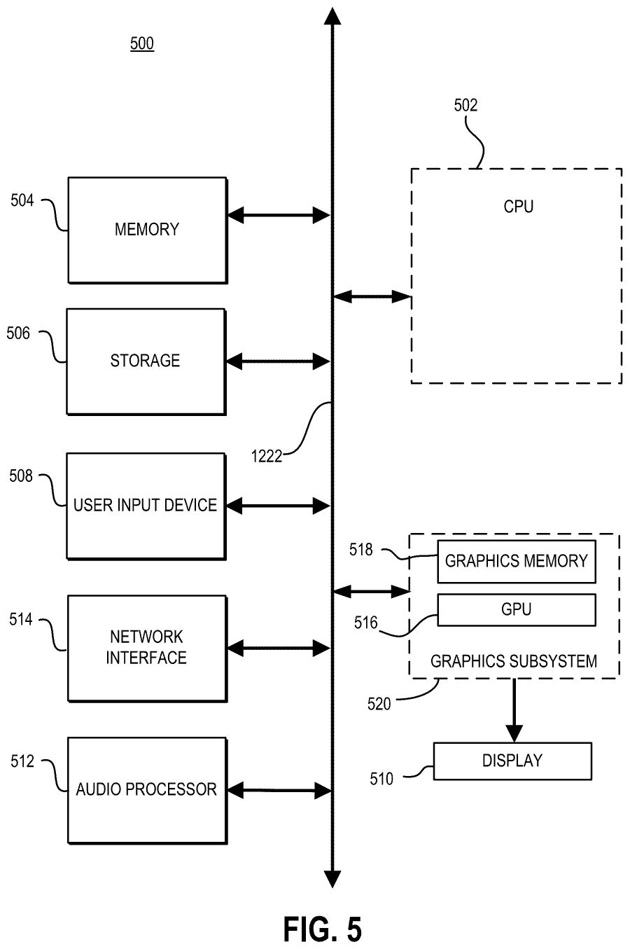

FIG. 5 illustrates components of an example device 500 that can be used to perform aspects of the various embodiments of the present disclosure. This block diagram illustrates a device 500 that can incorporate or can be a personal computer, video game console, personal digital assistant, a server or other digital device, suitable for practicing an embodiment of the disclosure. Device 500 includes a central processing unit (CPU) 502 for running software applications and optionally an operating system. CPU 502 may be comprised of one or more homogeneous or heterogeneous processing cores. For example, CPU 502 is one or more general-purpose microprocessors having one or more processing cores. Further embodiments can be implemented using one or more CPUs with microprocessor architectures specifically adapted for highly parallel and computationally intensive applications, such as processing operations of interpreting a query, identifying contextually relevant resources, and implementing and rendering the contextually relevant resources in a video game immediately. Device 500 may be localized to a player playing a game segment (e.g., game console), or remote from the player (e.g., back-end server processor), or one of many servers using virtualization in a game cloud system for remote streaming of gameplay to clients.

Memory 504 stores applications and data for use by the CPU 502. Storage 506 provides non-volatile storage and other computer readable media for applications and data and may include fixed disk drives, removable disk drives, flash memory devices, and CD-ROM, DVD-ROM, Blu-ray, HD-DVD, or other optical storage devices, as well as signal transmission and storage media. User input devices 508 communicate user inputs from one or more users to device 500, examples of which may include keyboards, mice, joysticks, touch pads, touch screens, still or video recorders/cameras, tracking devices for recognizing gestures, and/or microphones. Network interface 514 allows device 500 to communicate with other computer systems via an electronic communications network, and may include wired or wireless communication over local area networks and wide area networks such as the internet. An audio processor 512 is adapted to generate analog or digital audio output from instructions and/or data provided by the CPU 502, memory 504, and/or storage 506. The components of device 500, including CPU 502, memory 504, data storage 506, user input devices 508, network interface 510, and audio processor 512 are connected via one or more data buses 522.

A graphics subsystem 520 is further connected with data bus 522 and the components of the device 500. The graphics subsystem 520 includes a graphics processing unit (GPU) 516 and graphics memory 518. Graphics memory 518 includes a display memory (e.g., a frame buffer) used for storing pixel data for each pixel of an output image. Graphics memory 518 can be integrated in the same device as GPU 508, connected as a separate device with GPU 516, and/or implemented within memory 504. Pixel data can be provided to graphics memory 518 directly from the CPU 502. Alternatively, CPU 502 provides the GPU 516 with data and/or instructions defining the desired output images, from which the GPU 516 generates the pixel data of one or more output images. The data and/or instructions defining the desired output images can be stored in memory 504 and/or graphics memory 518. In one embodiment, the GPU 516 includes 3D rendering capabilities for generating pixel data for output images from instructions and data defining the geometry, lighting, shading, texturing, motion, and/or camera parameters for a scene. The GPU 516 can further include one or more programmable execution units capable of executing shader programs.

The graphics subsystem 514 periodically outputs pixel data for an image from graphics memory 518 to be displayed on display device 510. Display device 510 can be any device capable of displaying visual information in response to a signal from the device 500, including CRT, LCD, plasma, and OLED displays. Device 500 can provide the display device 510 with an analog or digital signal, for example.

It should be noted, that access services, such as providing access to games of the current embodiments, delivered over a wide geographical area often use cloud computing. Cloud computing is a style of computing in which dynamically scalable and often virtualized resources are provided as a service over the Internet. Users do not need to be an expert in the technology infrastructure in the “cloud” that supports them. Cloud computing can be divided into different services, such as Infrastructure as a Service (IaaS), Platform as a Service (PaaS), and Software as a Service (SaaS). Cloud computing services often provide common applications, such as video games, online that are accessed from a web browser, while the software and data are stored on the servers in the cloud. The term cloud is used as a metaphor for the Internet, based on how the Internet is depicted in computer network diagrams and is an abstraction for the complex infrastructure it conceals.

A game server may be used to perform the operations of the durational information platform for video game players, in some embodiments. Most video games played over the Internet operate via a connection to the game server. Typically, games use a dedicated server application that collects data from players and distributes it to other players. In other embodiments, the video game may be executed by a distributed game engine. In these embodiments, the distributed game engine may be executed on a plurality of processing entities (PEs) such that each PE executes a functional segment of a given game engine that the video game runs on. Each processing entity is seen by the game engine as simply a compute node.

Game engines typically perform an array of functionally diverse operations to execute a video game application along with additional services that a user experiences. For example, game engines implement game logic, perform game calculations, physics, geometry transformations, rendering, lighting, shading, audio, as well as additional in-game or game-related services. Additional services may include, for example, messaging, social utilities, audio communication, gameplay replay functions, help function, etc. While game engines may sometimes be executed on an operating system virtualized by a hypervisor of a particular server, in other embodiments, the game engine itself is distributed among a plurality of processing entities, each of which may reside on different server units of a data center.

According to this embodiment, the respective processing entities for performing the operations may be a server unit, a virtual machine, or a container, depending on the needs of each game engine segment. For example, if a game engine segment is responsible for camera transformations, that particular game engine segment may be provisioned with a virtual machine associated with a graphics processing unit (GPU) since it will be doing a large number of relatively simple mathematical operations (e.g., matrix transformations). Other game engine segments that require fewer but more complex operations may be provisioned with a processing entity associated with one or more higher power central processing units (CPUs).

By distributing the game engine, the game engine is provided with elastic computing properties that are not bound by the capabilities of a physical server unit. Instead, the game engine, when needed, is provisioned with more or fewer compute nodes to meet the demands of the video game. From the perspective of the video game and a video game player, the game engine being distributed across multiple compute nodes is indistinguishable from a non-distributed game engine executed on a single processing entity, because a game engine manager or supervisor distributes the workload and integrates the results seamlessly to provide video game output components for the end user.

Users access the remote services with client devices, which include at least a CPU, a display and I/O. The client device can be a PC, a mobile phone, a netbook, a PDA, etc. In one embodiment, the network executing on the game server recognizes the type of device used by the client and adjusts the communication method employed. In other cases, client devices use a standard communications method, such as HTML, to access the application on the game server over the internet. It should be appreciated that a given video game or gaming application may be developed for a specific platform and a specific associated controller device. However, when such a game is made available via a game cloud system as presented herein, the user may be accessing the video game with a different controller device. For example, a game might have been developed for a game console and its associated controller, whereas the user might be accessing a cloud-based version of the game from a personal computer utilizing a keyboard and mouse. In such a scenario, the input parameter configuration can define a mapping from inputs which can be generated by the user's available controller device (in this case, a keyboard and mouse) to inputs which are acceptable for the execution of the video game.

In another example, a user may access the cloud gaming system via a tablet computing device, a touchscreen smartphone, or other touchscreen driven device. In this case, the client device and the controller device are integrated together in the same device, with inputs being provided by way of detected touchscreen inputs/gestures. For such a device, the input parameter configuration may define particular touchscreen input corresponding to game inputs for the video game. For example, buttons, a directional pad, or other types of input elements might be displayed or overlaid during running of the video game to indicate locations on the touchscreen that the user can touch to generate a game input. Gestures such as swipes in particular directions or specific touch motions may also be detected as game inputs. In one embodiment, a tutorial can be provided to the user indicating how to provide input via the touchscreen for gameplay, e.g., prior to beginning gameplay of the video game, so as to acclimate the user to the operation of the controls on the touchscreen.

In some embodiments, the client device serves as the connection point for a controller device. That is, the controller device communicates via a wireless or wired connection with the client device to transmit inputs from the controller device to the client device. The client device may in turn process these inputs and then transmit input data to the cloud game server via a network (e.g., accessed via a local networking device such as a router). However, in other embodiments, the controller can itself be a networked device, with the ability to communicate inputs directly via the network to the cloud game server, without being required to communicate such inputs through the client device first. For example, the controller might connect to a local networking device (such as the aforementioned router) to send to and receive data from the cloud game server. Thus, while the client device may still be required to receive video output from the cloud-based video game and render it on a local display, input latency can be reduced by allowing the controller to send inputs directly over the network to the cloud game server, bypassing the client device.

In one embodiment, a networked controller and client device can be configured to send certain types of inputs directly from the controller to the cloud game server, and other types of inputs via the client device. For example, inputs whose detection does not depend on any additional hardware or processing apart from the controller itself can be sent directly from the controller to the cloud game server via the network, bypassing the client device. Such inputs may include button inputs, joystick inputs, embedded motion detection inputs (e.g., accelerometer, magnetometer, gyroscope), etc. However, inputs that utilize additional hardware or require processing by the client device can be sent by the client device to the cloud game server. These might include captured video or audio from the game environment that may be processed by the client device before sending to the cloud game server. Additionally, inputs from motion detection hardware of the controller might be processed by the client device in conjunction with captured video to detect the position and motion of the controller, which would subsequently be communicated by the client device to the cloud game server. It should be appreciated that the controller device in accordance with various embodiments may also receive data (e.g., feedback data) from the client device or directly from the cloud gaming server.

In one embodiment, the various technical examples can be implemented using a virtual environment via a head-mounted display (HMD). An HMD may also be referred to as a virtual reality (VR) headset. As used herein, the term “virtual reality” (VR) generally refers to user interaction with a virtual space/environment that involves viewing the virtual space through an HMD (or VR headset) in a manner that is responsive in real-time to the movements of the HMD (as controlled by the user) to provide the sensation to the user of being in the virtual space or metaverse. For example, the user may see a three-dimensional (3D) view of the virtual space when facing in a given direction, and when the user turns to a side and thereby turns the HMD likewise, then the view to that side in the virtual space is rendered on the HMD. An HMD can be worn in a manner similar to glasses, goggles, or a helmet, and is configured to display a video game or other metaverse content to the user. The HMD can provide a very immersive experience to the user by virtue of its provision of display mechanisms in close proximity to the user's eyes. Thus, the HMD can provide display regions to each of the user's eyes which occupy large portions or even the entirety of the field of view of the user, and may also provide viewing with three-dimensional depth and perspective.

In one embodiment, the HMD may include a gaze tracking camera that is configured to capture images of the eyes of the user while the user interacts with the VR scenes. The gaze information captured by the gaze tracking camera(s) may include information related to the gaze direction of the user and the specific virtual objects and content items in the VR scene that the user is focused on or is interested in interacting with. Accordingly, based on the gaze direction of the user, the system may detect specific virtual objects and content items that may be of potential focus to the user where the user has an interest in interacting and engaging with, e.g., game characters, game objects, game items, etc.

In some embodiments, the HMD may include an externally facing camera(s) that is configured to capture images of the real-world space of the user such as the body movements of the user and any real-world objects that may be located in the real-world space. In some embodiments, the images captured by the externally facing camera can be analyzed to determine the location/orientation of the real-world objects relative to the HMD. Using the known location/orientation of the HMD the real-world objects, and inertial sensor data from them, the gestures and movements of the user can be continuously monitored and tracked during the user's interaction with the VR scenes. For example, while interacting with the scenes in the game, the user may make various gestures such as pointing and walking toward a particular content item in the scene. In one embodiment, the gestures can be tracked and processed by the system to generate a prediction of interaction with the particular content item in the game scene. In some embodiments, machine learning may be used to facilitate or assist in said prediction.

During HMD use, various kinds of single-handed, as well as two-handed controllers can be used. In some implementations, the controllers themselves can be tracked by tracking lights included in the controllers, or tracking of shapes, sensors, and inertial data associated with the controllers. Using these various types of controllers, or even simply hand gestures that are made and captured by one or more cameras, it is possible to interface, control, maneuver, interact with, and participate in the virtual reality environment or metaverse rendered on an HMD. In some cases, the HMD can be wirelessly connected to a cloud computing and gaming system over a network. In one embodiment, the cloud computing and gaming system maintains and executes the video game being played by the user. In some embodiments, the cloud computing and gaming system is configured to receive inputs from the HMD and the interface objects over the network. The cloud computing and gaming system is configured to process the inputs to affect the game state of the executing video game. The output from the executing video game, such as video data, audio data, and haptic feedback data, is transmitted to the HMD and the interface objects. In other implementations, the HMD may communicate with the cloud computing and gaming system wirelessly through alternative mechanisms or channels such as a cellular network.

Additionally, though implementations in the present disclosure may be described with reference to a head-mounted display, it will be appreciated that in other implementations, non-head mounted displays may be substituted, including without limitation, portable device screens (e.g. tablet, smartphone, laptop, etc.) or any other type of display that can be configured to render video and/or provide for display of an interactive scene or virtual environment in accordance with the present implementations. It should be understood that the various embodiments defined herein may be combined or assembled into specific implementations using the various features disclosed herein. Thus, the examples provided are just some possible examples, without limitation to the various implementations that are possible by combining the various elements to define many more implementations. In some examples, some implementations may include fewer elements, without departing from the spirit of the disclosed or equivalent implementations.

Embodiments of the present disclosure may be practiced with various computer system configurations including hand-held devices, microprocessor systems, microprocessor-based or programmable consumer electronics, minicomputers, mainframe computers and the like. Embodiments of the present disclosure can also be practiced in distributed computing environments where tasks are performed by remote processing devices that are linked through a wire-based or wireless network.

Although the method operations were described in a specific order, it should be understood that other housekeeping operations may be performed in between operations, or operations may be adjusted so that they occur at slightly different times or may be distributed in a system which allows the occurrence of the processing operations at various intervals associated with the processing, as long as the processing of the telemetry and game state data for generating modified game states and are performed in the desired way.

One or more embodiments can also be fabricated as computer readable code on a computer readable medium. The computer readable medium is any data storage device that can store data, which can thereafter be read by a computer system. Examples of the computer readable medium include hard drives, network attached storage (NAS), read-only memory, random-access memory, CD-ROMs, CD-Rs, CD-RWs, magnetic tapes and other optical and non-optical data storage devices. The computer readable medium can include computer readable tangible medium distributed over a network-coupled computer system so that the computer readable code is stored and executed in a distributed fashion.

In one embodiment, the video game is executed either locally on a gaming machine, a personal computer, or on a server. In some cases, the video game is executed by one or more servers of a data center. When the video game is executed, some instances of the video game may be a simulation of the video game. For example, the video game may be executed by an environment or server that generates a simulation of the video game. The simulation, on some embodiments, is an instance of the video game. In other embodiments, the simulation maybe produced by an emulator. In either case, if the video game is represented as a simulation, that simulation is capable of being executed to render interactive content that can be interactively streamed, executed, and/or controlled by user input.

Although the foregoing embodiments have been described in some detail for purposes of clarity of understanding, it will be apparent that certain changes and modifications can be practiced within the scope of the appended claims. Accordingly, the present embodiments are to be considered as illustrative and not restrictive, and the embodiments are not to be limited to the details given herein, but may be modified within the scope and equivalents of the appended claims.

What is claimed is:

1. A method for generating chat communication in a video game, comprising,
accessing a gameplay database that includes dialog scripts from player interactions occurring during interactive scenarios of a cooperative video game;
processing the dialog scripts to extract chat words between real players during the cooperative video game and labeling the chat words to correlate the chat words to one or more interactive scenarios and correlate the chat words to a game context, wherein over time an artificial intelligence (AI) model is trained using the chat words that are labeled to learn a chat style for the cooperative video game;
identifying a non-player character (NPC), during an instance of gameplay of the cooperative video game, the NPC is surfaced in the cooperative video game while an avatar of a real player is present in a scene of the cooperative video game;
detecting a location of the NPC in the scene to determine if the NPC is within a chat proximity to the real player; and
generating one or more NPC chat words for the NPC consistent with the chat style of the cooperative video game using the AI model, the NPC chat words being audible to the real player and visually depicted as being output by the NPC toward the real player.

2. The method of claim 1, wherein the labeling of said chat words occurs after a normalizing function to filter out words from the dialog scripts, wherein the normalizing function assists in identifying a relevance factor of the words in relation to the interactive scenarios and in relation to the game context, such that one or more of the words are not used as input to the AI model for training.

3. The method of claim 2, wherein the labeling includes tagging single words or groups of words from the chat words with context markers that assist in relating the chat words to said interactive scenarios and relating the chat words to the game context.

4. The method of claim 3, wherein said training of the AI model enables the AI model to predict chat words that are appropriate for a current interactive scenario based on real-time context analysis,
wherein the real-time context analysis identifies a time window during which said NPC is enabled to output said NPC chat words, wherein if the time window is expired for said current interactive scenario, then said NPC will not output said NPC chat words even when the real player is within the chat proximity to the NPC.

5. The method of claim 1, wherein training said AI model further includes providing the AI model with custom chat words that relate to the cooperative video game or specific cooperative video games to fine tune the AI model.

6. The method of claim 1, wherein the identifying the NPC in the scene of the cooperative video game includes game state monitoring, wherein the game state monitoring includes analysis of game state during interactivity of the cooperative video game.

7. The method of claim 1, wherein the avatar of the real player is controlled by the real player in the scene and other scenes of the cooperative video game and the avatar is made to interact in one or more of the interactive scenarios, where said interaction in the one or more of the interactive scenarios by the avatar continually updates said game context.

8. The method of claim 1, wherein during said interaction by the avatar in the one or more interactive scenarios data is processed by the AI model to identify said NPC chat words.

9. The method of claim 8, wherein real-time context analysis identifies a time window during which said NPC is enabled to output said NPC chat words.

10. The method of claim 8, wherein if the time window is expired, then said NPC will not output said NPC chat words toward the avatar of the real player even when the real player is within the chat proximity to the NPC.

11. The method of claim 1, wherein the NPC chat words are throttled in output frequency based on an engagement level of the real player that controls the avatar, the engagement level is in part based on actions currently being taken by the player in the scene and state data analysis that identifies actions being taken by the player or required to be taken by the player in the interactive scenarios of the cooperative video game.

12. The method of claim 1, wherein the NPC chat words are throttled based on a user preference setting that identify a level of engagement desired for the NPC or other NPCs in the scene during the interactive scenarios of the cooperative video game.

13. The method of claim 12, wherein the user preference setting includes an interactive sliding scale that sets the level of engagement desired for the NPC or other NPCs, wherein the level of engagement indicates whether the NPC or other NPCs should more aggressively or less aggressively chat with the avatar of the real player.

14. The method of claim 1, wherein the AI model is used to modify the NPC chat words for urgency triggered by the game context, wherein more urgency requires the NPC chat words to be delivered by the NPC to the real player in a language format that is briefer and more specific.

15. A method for generating chat communication in a video game, comprising,
accessing a gameplay database that includes dialog scripts from player interactions occurring during interactive scenarios of a cooperative video game;
processing the dialog scripts to extract chat words between real players during the cooperative video game and labeling the chat words to correlate the chat words to one or more interactive scenarios and correlate the chat words to a game context, wherein over time an artificial intelligence (AI) model is trained using the chat words that are labeled to learn contextually relevant chat words for the cooperative video game;
identifying a non-player character (NPC), during an instance of gameplay of the cooperative video game, the NPC is present in the cooperative video game while an avatar of a real player is present in a scene of the cooperative video game;
generating one or more NPC chat words for the NPC using the AI model, the NPC chat words being audible to the real player.

16. The method of claim 15, wherein a location of the NPC in the scene is identified to determine if the NPC is within a chat proximity to the real player.

17. The method of claim 15, wherein said training of the AI model enables the AI model to predict chat words that are appropriate for a current interactive scenario, and a time window is identified during which said NPC is enabled to output said NPC chat words.

18. The method of claim 17, wherein if the time window is expired for said current interactive scenario, then said NPC will not output said NPC chat words even when the real player is within the chat proximity to the NPC.

19. The method of claim 15, wherein the NPC chat words are throttled in output frequency based on an engagement level of the real player that controls the avatar, the engagement level is in part based on actions currently being taken by the player in the scene and state data analysis that identifies actions being taken by the player or required to be taken by the player in the interactive scenarios of the cooperative video game.

20. The method of claim 15, wherein the NPC chat words are throttled based on a user preference setting that identify a level of engagement desired for the NPC or other NPCs in the scene during the interactive scenarios of the cooperative video game.
